(19) United States
(12) Patent Application Publication
(10) Pub. No.: US 2003/0234753 A1
(43) Pub. Date: Dec. 25, 2003

(54) Plasma display panel and method of driving the same

(75) Inventor: Yoshito Tanaka, Tokyo (JP)

Correspondence Address: SUGHRUE, MION, ZINN, MACPEAK & SEAS, 2100 Pennsylvania Avenue, N.W., Washington, DC, 20037, US

(73) Assignee: NEC PLASMA DISPLAY CORPORATION

(21) Appl. No.: 10/465,638

(22) Filed: Jun. 20, 2003

(30) Foreign Application Priority Data
Jun. 20, 2002 (JP) 2002-179734

(51) Int. Cl. G09G 3/28

(52) U.S. Cl. 345/67

(57) ABSTRACT

A method of drives a plasma display panel including first and second substrates facing each other, a plurality of first and second electrodes extends on the first substrate in a first direction such that each of the second electrodes makes a pair with each of the first electrodes located adjacent thereto, and a plurality of third electrodes extending on the second substrate in a second direction perpendicular to the first direction. The method includes the steps of dividing a field into a plurality of sub-fields having at least two weighted luminance, (b) selecting whether discharge is to be generated between the first or second and third electrodes for controlling a gray scale, (c) weighting the luminance by varying the number of application of sustaining pulses to the first or second electrode, and (d) stopping application of the sustaining pulses in at least one sub-field among the plurality of sub-fields.

### BACKGROUND OF THE INVENTION

1. Field of the Invention

The invention relates to a plasma display panel which controls a gray scale in accordance with a sub-field process, and a method of driving the same.

2. Description of the Related Art

Hereinbelow are explained a conventional plasma display panel, a conventional method of driving the same, and a conventional method of controlling a luminance in a plasma display panel.

FIG. 1 is a partially exploded perspective view of a conventional plasma display panel.

As illustrated in FIG. 1, a plasma display panel includes an electrically insulating front substrate 201 and an electrically insulating rear substrate 301.

On the front substrate 201 are formed a plurality of transparent scanning electrodes 2 and a plurality of transparent sustaining electrodes 3. A trace electrode 4 is formed overlapping the scanning and sustaining electrodes 2 and 3 in order to reduce a resistance of the scanning and sustaining electrodes 2 and 3.

On the front substrate 201 is formed a first dielectric layer 9 entirely covering the scanning and sustaining electrodes 2 and 3 therewith. A protection layer 10 is formed entirely over the first dielectric layer 9 in order to protect the first dielectric layer 9 from discharge. For instance, the protection layer 10 is composed of magnesium oxide.

On the rear substrate 301 is formed a plurality of data electrodes 5 extending perpendicularly to the scanning and sustaining electrodes 2 and 3. On the rear substrate 301 is formed a second dielectric layer 11 entirely covering the data electrodes 5 therewith.

On the second dielectric layer 11 is formed a plurality of partition walls 7 extending in parallel with the data electrodes 5 and defining display cells. On sidewalls of the partition walls 7 and an exposed surface of the second dielectric layer 11 is formed a phosphor layer 8 which converts an ultra-violet ray generated by discharge of discharge gas, into visible light.

Spaces sandwiched between the front and rear substrates 201 and 301 and partitioned by the partition walls 7 define discharge spaces 6 filled with discharge gas composed of helium, neon or xenon alone or in combination.

In the plasma display panel illustrated in FIG. 1, surface discharges 100 are generated between the scanning and sustaining electrodes 2 and 3.

Hereinbelow is explained an operation of a display cell.

FIG. 2 is a timing chart showing waveforms of voltage pulses applied to the scanning electrode 2, the sustaining electrode 3 and the data electrode 5 in a conventional method of driving a plasma display panel.

As illustrated in FIG. 2, one sub-field includes a preliminary discharge period (A) in which preliminary discharge pulses are applied to electrodes for causing discharges to be readily generated in the subsequent period (B), a selection period (B) in which it is selected which display cell or cells is(are) to be turned on or off, a sustaining period (C) in which discharges are generated in all of the selected display cells, and an eliminating period (D) in which discharges are stopped.

In a conventional method of driving a plasma display panel, a reference voltage of the scanning electrodes 2 and the sustaining electrodes 3 is set equal to a sustaining voltage Vos which keeps discharges generated, if applied to the scanning and sustaining electrodes 2 and 3. Hence, with respect to the scanning and sustaining electrodes 2 and 3, a voltage higher than the sustaining voltage Vos is expressed as a positive voltage, and a voltage lower than the sustaining voltage Vos is expressed as a negative voltage hereinafter. A reference voltage of the data electrodes 5 is set equal to zero (0) volt.

In the preliminary discharge period (A), a positive and serrate preliminary discharge pulse Pops is applied to the scanning electrodes 2, and concurrently, a negative and rectangular preliminary discharge pulse Popc is applied to the sustaining electrode 3. The preliminary discharge pulses Pops and Popc are designed to have a wave-height or a maximum voltage higher than a threshold voltage at which discharge is generated between the scanning and sustaining electrodes 2 and 3. Accordingly, by applying the preliminary discharge pulses Pops and Popc to the scanning and sustaining electrodes 2 and 3, respectively, weak discharge is generated between the scanning and sustaining electrodes 2 and 3 when the serrate preliminary discharge pulse Pops rises, and resultingly, a voltage between the scanning and sustaining electrodes 2 and 3 is over the above-mentioned threshold voltage. As a result, negative wall charges are accumulated on the scanning electrodes 2, and positive wall charges are accumulated on the sustaining electrodes 3.

Subsequently to the application of the preliminary discharge pulse Pops to the scanning electrodes 2, a negative and serrate preliminary discharge eliminating pulse Pope is applied to the scanning electrodes 2, while the sustaining electrodes 3 are kept at a sustaining voltage Vos. By application of the preliminary discharge eliminating pulse Pope, wall charges accumulated on the scanning and sustaining electrodes 2 and 3 are eliminated.

Elimination of the wall charges in the preliminary discharge period (A) causes the operation to be properly carried out in the subsequent periods.

In the selection period (B), all of the scanning electrodes 2 are once kept at a base voltage Vobw. Thereafter, a negative scanning pulse Pow is applied to each of the scanning electrodes 2 in turn, and a data pulse Pod is applied to the data electrodes 5 in accordance with display data. While application of the scanning pulse Pow and the data pulse Pod to the scanning electrodes 2 and the data electrodes 5, respectively, the sustaining electrodes 3 are kept at a positive voltage Vosw.

A voltage of the scanning pulse Pow and the data pulse Pod is determined such that if one of the scanning pulse Pow and the data pulse Pod is applied to the scanning electrodes 2 and the data electrodes 5, a voltage between the scanning electrodes 2 and the data electrodes 5 would not be over a threshold voltage at which discharge is generated between the scanning electrodes 2 and the data electrodes 5, but if both of the scanning pulse Pow and the data pulse Pod are applied to the scanning electrodes 2 and the data electrodes 5, a voltage between the scanning electrodes 2 and the data electrodes 5 would be over the threshold voltage.

In the selection period (B), the voltage Vosw of the sustaining electrodes 3 is designed to have such a magnitude that a voltage between the scanning and sustaining electrodes 2 and 3 is not over a threshold voltage at which discharge is generated between the scanning and sustaining electrodes 2 and 3, even if the voltage Vosw is added to the scanning pulse Pow.

Accordingly, discharge is generated between the scanning and data electrodes 2 and 5 only in display cells in which the scanning pulse Pow is applied to the scanning electrodes 2 and the data pulse Pod is applied to the data electrodes 5. Since a voltage difference caused by the scanning pulses Pow and Vosw is applied across the scanning electrodes 2 and the sustaining electrodes 3, discharge is generated further between the scanning and sustaining electrodes 2 and 3 with the discharge generated between the scanning electrodes 2 and the data electrodes 5, acting as a trigger. The discharge between the scanning electrodes 2 and the sustaining electrodes 3 is so-called writing discharge.

As a result, positive wall charges are accumulated on the scanning electrodes 2, and negative wall charges are accumulated on the sustaining electrodes 3 in the selected display cells.

In the sustaining period (C), while all of the scanning electrodes 2 are kept at the sustaining voltage Vos, a first sustaining pulse Posf is applied to the sustaining electrodes 3. The sustaining voltage Vos is designed to have such a magnitude that discharge is generated between the scanning and sustaining electrodes 2 and 3, if a voltage caused by wall charges having been accumulated on the scanning and sustaining electrodes 2 and 3 by the writing discharge in the selection period (B) is added to the sustaining voltage Vos, but a voltage between the scanning and sustaining electrodes 2 and 3 would not be over a threshold voltage at which discharge is generated between the scanning and sustaining electrodes 2 and 3, and hence, discharge is not generated, if the voltage caused by the wall charges is not added to the sustaining voltages Vos.

Accordingly, a sustaining discharge is generated only in display cells in which wall charges are accumulated on the electrodes by the writing discharge having been generated in the selection period (B).

Subsequently, sustaining pulses Pos having a voltage equal to the sustaining voltage Vos and having phases opposite to each other are applied to the scanning and sustaining electrodes 2 and 3. As a result, a sustaining discharge is generated only in display cells in which a discharge has been generated by the first sustaining pulse Posf.

In the subsequent eliminating period (D), the sustaining electrodes 3 are kept at the sustaining voltage Vos, and a negative and serrate eliminating pulse Poe is applied to the scanning electrodes 2. Thus, wall charges accumulated on the scanning and sustaining electrodes 2 and 3 are eliminated. That is, the plasma display panel is returned back to its initial state, specifically, a state prior to the application of the preliminary discharge pulses Pops and Popc into the scanning and sustaining electrodes 2 and 3 in the preliminary discharge period (A).

Elimination of the wall charges in the elimination period (D) causes the operation to be properly carried out in the subsequent periods.

Apart from a method of driving a plasma display panel in which the selection period (B) and the sustaining period (C) are separately carried out, there has been suggested a method of driving a plasma display panel in which the selection period (B) and the sustaining period (C) are carried out in combination. However, the latter is identical with the former with respect to each of display cells in that the selection period and the sustaining period are arranged subsequently to the preliminary discharge period.

Hereinbelow is explained a conventional method of controlling a luminance of a plasma display panel.

In driving a plasma display panel, a sub-field process is carried out for controlling a gray scale. This is because it is difficult in an AC-type plasma display unit to modulate a luminance through a voltage, and hence, it is necessary to vary the number of light-emission for modulating a luminance. In a sub-field process, an image having a certain gray scale is divided into a plurality of binary-coded images, and those images are successively displayed at a high rate to thereby reproducing an image having a high gray scale, by virtue of visual integration effect.

When an image is displayed at 8-bits and 256 gray scales, a field is divided into eight sub-fields (SFs) each of which is designed to have a luminance at a proportion of 1: 2: 4: 8: 16: 32: 64: 128. Thus, it is possible to accomplish a desired gray scale by selecting a sub-field or sub-fields in which discharges are generated, in accordance with a luminance level of an input signal.

A luminance in each of sub-fields is determined by varying the number of sustaining cycles in the sustaining period (C).

An efficiency at which a plasma display panel emits light is not so high. Accordingly, when an image is displayed brightly, for instance, when all of display cells in a screen are turned on, the number of sustaining cycles to be applied in a field is limited due to power consumption and/or a heat problem in a panel and/or circuits.

On the other hand, when an average luminance is relatively low, it would be possible to vividly display an image by increasing the number of sustaining pulses in a field to thereby increase a peak luminance.

As mentioned above, in a conventional method of controlling a luminance in a plasma display panel, an average picture level (APL) in a screen is detected, and if the detected average picture level is relatively low, the number of sustaining discharge cycles in a field is increased for displaying an image at a high gray scale, whereas if the detected average picture level is relatively high, the number of sustaining discharge cycles in a field is reduced for reduce power consumption caused by light emission.

Table 1 shows a relation between an average picture level (APL) and the number of sustaining cycles in each of sub-fields when an image is displayed in eight sub-fields at 256 gray scales.

In Table 1, there are listed four average picture levels where the lowest average picture level is equal to zero (0), and the highest average picture level at which a screen is made almost white is equal to three (3).

At the highest average picture level 3 at which a screen is almost white, the number of sustaining cycles is equal to 255 at the highest luminance level 255. At the lowest average picture level 0 at which a peak luminance is given, the number of sustaining cycles is equal to 1020 at the luminance level 255. Thus, the sustaining cycles are applied at the lowest average picture level 0 four times greater than the sustaining cycles to be applied at the highest average picture level 3, and hence, there is accomplished a peak luminance approximately four times higher than a peak luminance accomplished at the highest average picture level 3.

TABLE 1

| APL | SF1 | SF2 | SF3 | SF4 | SF5 | SF6 | SF7 | SF8 | Total |
|---|---|---|---|---|---|---|---|---|---|
| 3 | 1 | 2 | 4 | 8 | 16 | 32 | 64 | 128 | 255 |
| 2 | 2 | 4 | 8 | 16 | 32 | 64 | 128 | 256 | 510 |
| 1 | 3 | 6 | 12 | 24 | 48 | 96 | 192 | 384 | 765 |
| 0 | 4 | 8 | 16 | 32 | 64 | 128 | 256 | 512 | 1020 |

Since the small number of display cells emit light, even though the number of sustaining cycles is increased, small power is consumed by light emission, ensuring no increase in power consumption. Hence, maximum power is consumed when all of display cell are on in a screen, that is, when a screen is made white. Accordingly, it is possible to increase a peak luminance even if an average picture level is relatively low, without an increase in maximum power consumption.

An average picture level (APL) can be detected in accordance with various methods. Since a plasma display panel receives and transmits luminance data in the form of a digital signal, an average picture level can be readily detected by simple processing of digital signals. The number of sustaining cycles in each of sub-fields in association with each of average picture levels can be readily determined by virtue of a look-up table (LUT), for instance.

The above-mentioned method of controlling a luminance in which the number of sustaining cycles is controlled in accordance with data associated with an average picture level for reducing maximum power consumption and/or increasing a peak luminance is called a power-saving method or peak level enlarging (PLE) method. For instance, Japanese Patent Application Publication No. 2000-322025 has suggested such a PLE method.

FIG. 3 is a timing chart showing voltage pulses to be applied to each of electrodes in first and second sub-fields (SF1 and SF2) when an average peak level (APL) is three (3).

The number of discharges in the sustaining period (C) in the first sub-field (SF1) is just one, that is, the discharge caused by the first sustaining pulse. However, since discharge between the scanning and sustaining electrodes is generated due to writing discharge also in the selection period (B), the number of light-emission cycle can be counted as one, and a luminance corresponds to one cycle of sustaining discharge. Accordingly, the number of sustaining cycles shown in Table 1 includes the discharge generated between the scanning and sustaining electrodes due to writing discharge as 0.5.

A plasma display panel is fabricated larger in size year by year, resulting in that power consumption is increased. If an attempt is made to suppress an increase in power consumption is accordance with the above-mentioned PLE method, the number of sustaining cycles would be reduced when an average picture level is relatively high. On the other hand, since a conventional method of driving a plasma display panel cannot accomplish a gray scale equal to or greater than the number of sustaining cycles per a field, it would be impossible to display an image at 256 gray scales or at full color, if the number of sustaining cycles is equal to or smaller than 255.

Recently, a higher and higher luminance can be obtained by single discharge, and hence, a desired luminance can be accomplished with the smaller number of sustaining cycles. If the number of sustaining cycles were reduced, ineffective power consumed in charging and discharging of a capacity would be reduced, even if a light-emission efficiency is kept unchanged. Accordingly, it would be possible to reduce power consumption in a plasma display panel.

However, if a lower limit of the number of sustaining cycles is determined for ensuring repeatability of a gray scale, it would not be possible to reduce the number of sustaining cycles below the lower limit, resulting in an increase in power consumption.

A demand for display performance becomes higher and higher. Hence, it is necessary to accomplish image-display at a higher gray scale. If an image is displayed at 9-bit and 512 gray scales, it would be necessary to carry out 511 sustaining cycles even for an image having a high average picture level, resulting in that power consumption caused by light emission is doubled in comparison with conventional image-display at 8-bit and 256 gray scales.

In addition, since a plasma display panel is a capacitive device, ineffective power caused by charging and discharging of a capacity would be increased, if the number of sustaining cycles were increased, resulting in an increase in power consumption.

Japanese Patent Application Publication No. 2000-284748 has suggested an AC-type plasma display panel in which it is judged whether a luminance in the darkest area in a displayed image is smaller than a predetermined luminance, and if a luminance in the darkest area in a displayed image is higher than the predetermined luminance, the number of sustaining discharge pulses in at least one sub-field is increased over the number of sustaining discharge pulses which number is determined when a luminance in the darkest area in a displayed image is smaller than the predetermined luminance.

Japanese Patent Application Publication No. 11-65520 has suggested a plasma display panel in which a maximum gray scale is detected line by line, and the number of sustaining discharges is reduced in a sub-field(s) assigned to image-display at a maximum bit, in accordance with a difference in luminance between a maximum bit and the maximum gray scale, in line(s) in which the maximum gray scale does not reach the maximum bit corresponding to the number of bits at which an image signal is converted into a digital signal.

### SUMMARY OF THE INVENTION

In view of the above-mentioned problems in the conventional method of driving a plasma display panel, it is an object of the present invention to provide a method of driving a plasma display panel and a plasma display panel both of which are capable of increasing the number of gray scales without an increase in the number of the sustaining cycles, and display images without an increase in power consumption.

In one aspect of the present invention, there is provided a method of driving a plasma display panel including (a) a first substrate, (b) a second substrate located facing the first substrate, (c) a plurality of first electrodes arranged on a surface of the first substrate which surface faces the second substrate, and extending in a first direction, (d) a plurality of second electrodes arranged on the surface of the first substrate and extending in the first direction such that each of the second electrodes makes a pair with each of the first electrodes located adjacent thereto, and (e) a plurality of third electrodes arranged on a surface of the second substrate which surface faces the first substrate, and extending in a second direction perpendicular to the first direction, wherein a display cell is arranged at each of intersections of the first/second electrodes and the third electrodes, the method includes the steps of (a) dividing a field into a plurality of sub-fields having at least two weighted luminance, (b) selecting whether discharge is to be generated between the first or second and third electrodes for controlling a gray scale, (c) weighting the luminance by varying the number of application of sustaining pulses to the first or second electrode, and (d) stopping application of the sustaining pulses to the first or second electrode in at least one sub-field among the plurality of sub-fields.

It is preferable that the sub-field in which application of the sustaining pulses to the first or second electrode is stopped includes a step (e) of generating discharge between the first and second electrodes in the step (b).

It is preferable that the sub-field in which application of the sustaining pulses to the first or second electrode is stopped includes a step (D) of reducing at least one of wall charges accumulated on a surface of the first electrode and wall charges accumulated on a surface of the second electrode after the step (b).

The step (f) may include a step (g) of generating self-eliminating discharge by virtue of the wall charges accumulated on surfaces of the first and second electrodes.

The step (i) may include a step (h) of generating discharge between the second and third electrodes.

For instance, the step (g) is caused by a step (i) of generating discharge between the second and third electrodes.

It is preferable that the discharge in the step (i) is self-eliminating discharge generated by virtue of wall charges accumulated on surfaces of the second and third electrodes.

It is preferable that the sub-field in which application of the sustaining pulses to the first or second electrode is stopped provides the lowest luminance in the field.

There is further provided a method of driving a plasma display panel including (a) a first substrate, (b) a second substrate located facing the first substrate, (c) a plurality of first electrodes arranged on a surface of the first substrate which surface faces the second substrate, and extending in a first direction, (d) a plurality of second electrodes arranged on the surface of the first substrate and extending in the first direction such that each of the second electrodes makes a pair with each of the first electrodes located adjacent thereto, and (e) a plurality of third electrodes arranged on a surface of the second substrate which surface faces the first substrate, and extending in a second direction perpendicular to the first direction, wherein a display cell is arranged at each of intersections of the first/second electrodes and the third electrodes, the method includes the steps of (a) dividing a field into a plurality of sub-fields having at least two weighted luminance, (b) selecting whether discharge is to be generated between the first or second and third electrodes for controlling a gray scale, (c) weighting the luminance by varying the number of application of sustaining pulses to the first or second electrode, (d) varying the total number of the sustaining pulses to be applied to the first or second electrode during a field, in accordance with brightness of images, and (e) stopping application of the sustaining pulses to the first or second electrode in at least one sub-field among the plurality of sub-fields, when the total number of the sustaining pulses is equal to or smaller than a threshold.

In another aspect of the present invention, there is provided a plasma display panel including (a) a first substrate, (b) a second substrate located facing the first substrate, (c) a plurality of first electrodes arranged on a surface of the first substrate which surface faces the second substrate, and extending in a first direction, (d) a plurality of second electrodes arranged on the surface and extending in the first direction such that each of the second electrodes makes a pair with each of the first electrodes located adjacent thereto, and (e) a plurality of third electrodes arranged on a surface of the second substrate which surface faces the first substrate, and extending in a second direction perpendicular to the first direction, wherein a display cell is arranged at each of intersections of the first/second electrodes and the third electrodes, a field is divided into a plurality of sub-fields having at least two weighted luminance, a gray scale is controlled by selecting whether discharge is to be generated between the first or second and third electrodes, the number of application of sustaining pulses to the first or second electrode is varied for weighting the luminance, and application of the sustaining pulses to the first or second electrode is stopped in at least one sub-field among the plurality of sub-fields.

There is further provided a plasma display panel including (a) a first substrate, (b) a second substrate located facing the first substrate, (c) a plurality of first electrodes arranged on a surface of the first substrate which surface faces the second substrate, and extending in a first direction, (d) a plurality of second electrodes arranged on the surface and extending in the first direction such that each of the second electrodes makes a pair with each of the first electrodes located adjacent thereto, and (e) a plurality of third electrodes arranged on a surface of the second substrate which surface faces the first substrate, and extending in a second direction perpendicular to the first direction, wherein a display cell is arranged at each of intersections of the first/second electrodes and the third electrodes, a field is divided into a plurality of sub-fields having at least two weighted luminance, a gray scale is controlled by selecting whether discharge is to be generated between the first or second and third electrodes, the number of application of sustaining pulses to the first or second electrode is varied for weighting the luminance, the total number of the sustaining pulses to be applied to the first or second electrode during a field is varied in accordance with brightness of images, and application of the sustaining pulses to the first or second electrode is stopped in at least one sub-field among the plurality of sub-fields, when the total number of the sustaining pulses is equal to or smaller than a threshold.

It is preferable that the sub-field in which application of the sustaining pulses to the first or second electrode is stopped provides the lowest luminance in the field.

The advantages obtained by the aforementioned present invention will be described hereinbelow.

As explained above, in accordance with the present invention, sustaining pulses are not applied to sustaining electrodes in at least one sub-field among a plurality of sub-fields in a plasma display panel in which one field is divided into a plurality of sub-fields, and the number of sustaining cycles is varied in accordance with a luminance of a display cell.

Thus, it is possible to accomplish gray scale in the number approximately twice greater than the number of sustaining cycles in one field without exerting much influence on driving characteristics and further without an increase in power consumption.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a partially exploded perspective view of a conventional plasma display panel.

FIG. 2 is a timing chart showing waveforms of voltage pulses applied to scanning electrode, sustaining electrode and data electrode in a conventional method of driving a plasma display panel.

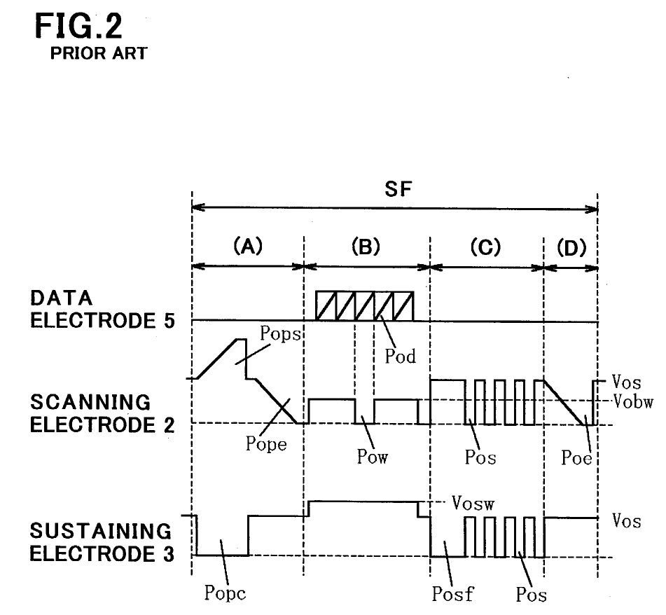

FIG. 3 is a timing chart showing voltage pulses to be applied to each of electrodes in first and second sub-fields when an average peak level (APL) is three (3).

FIG. 4 is a timing chart showing waveforms of voltage pulses applied to scanning electrode, sustaining electrode and data electrode in a method of driving a plasma display panel, in accordance with the first embodiment of the present invention.

FIGS. 5A to 5C illustrate wall charged accumulated on scanning and sustaining electrodes in a display cell in the first embodiment.

FIGS. 6A and 6B illustrate wall charged accumulated on scanning and sustaining electrodes in a display cell in the first embodiment.

FIG. 7 is a timing chart showing waveforms of voltage pulses applied to scanning electrode, sustaining electrode and data electrode in a method of driving a plasma display panel, in accordance with the second embodiment of the present invention.

FIGS. 8A and 8B illustrate wall charged accumulated on scanning and sustaining electrodes in a display cell in the second embodiment.

FIGS. 9A and 9B illustrate wall charged accumulated on scanning and sustaining electrodes in a display cell in the second embodiment.

FIG. 10 is a timing chart showing waveforms of voltage pulses applied to scanning electrode, sustaining electrode and data electrode in a method of driving a plasma display panel, in accordance with the third embodiment of the present invention.

### DESCRIPTION OF THE PREFERRED EMBODIMENTS

Preferred embodiments in accordance with the present invention will be explained hereinbelow with reference to drawings.

[First Embodiment]

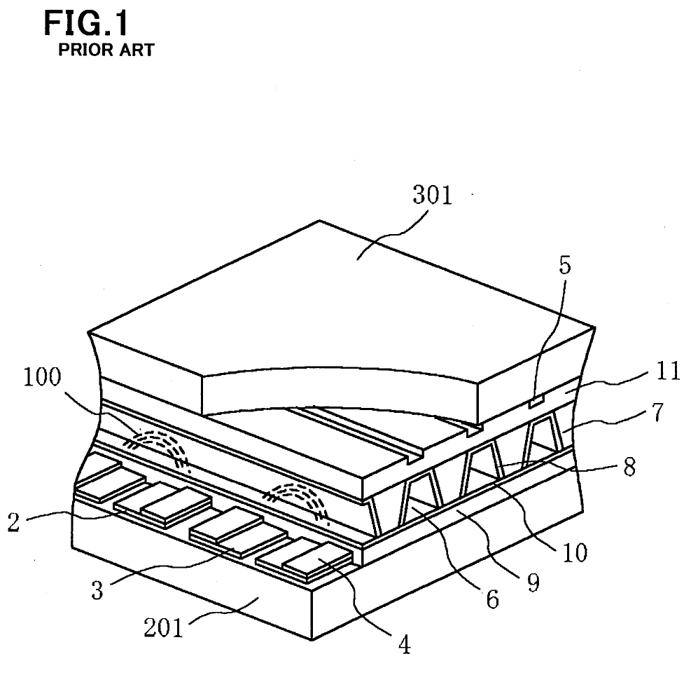

A method of driving a plasma display panel, in accordance with the first embodiment of the present invention, drives a plasma display panel having the same structure as the structure of the conventional plasma display panel illustrated in FIG. 1.

Hereinbelow is explained an operation of the plasma display panel.

First, a method of controlling a gray scale is explained hereinbelow. The method of controlling a gray scale is basically identical with a conventional method of driving a plasma display panel.

A field defining one image plane is divided into eight sub-fields to each of which a luminance is assigned at a proportion shown in Table 2.

TABLE 2

| | SF1 | SF2 | SF3 | SF4 | SF5 | SF6 | SF7 | SF8 |
|---|---|---|---|---|---|---|---|---|
| Weight | 1 | 2 | 4 | 8 | 16 | 32 | 64 | 128 |

Hereinbelow is explained a method of driving a plasma display panel, including the steps of selecting a sub-field, and carrying out light-emission at a desired luminance.

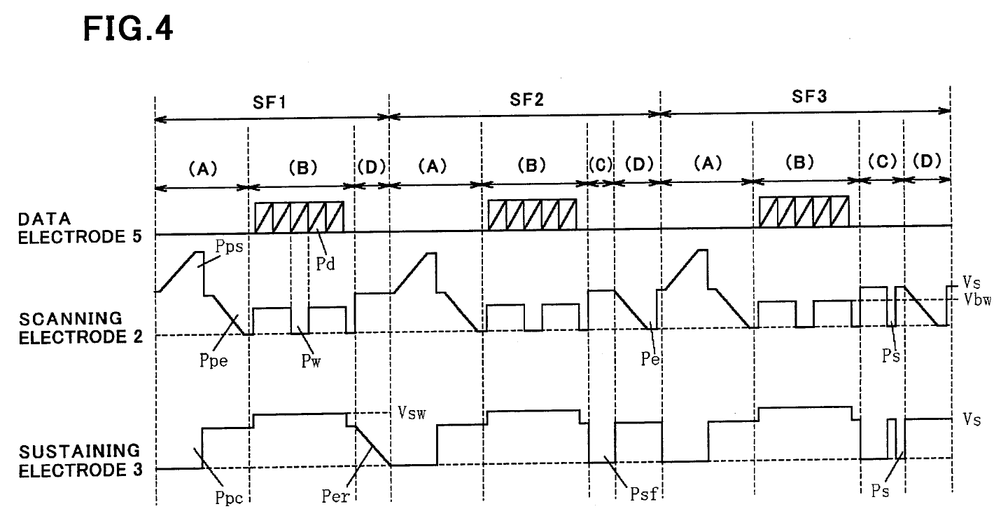

FIG. 4 is a timing chart showing waveforms of voltage pulses applied to scanning electrodes, sustaining electrodes and data electrodes in a method of driving a plasma display panel, in accordance with the first embodiment of the present invention.

A first sub-field (SF1) is designed to have a weight of one (1), that is, the lowest weight. A second sub-field (SF2) is designed to have a weight of 2, and a third sub-field (SF3) is designed to have a weight of 4. FIG. 4 illustrates a case in which an average picture level (APL) of an image plane is relatively high, that is, the number of sustaining cycles per a field is reduced.

With reference to FIG. 4, one sub-field includes a preliminary discharge period (A) in which preliminary discharge pulses are applied to electrodes for causing discharges to be readily generated in the subsequent period (B), a selection period (B) in which it is selected which display cell or cells is(are) to be turned on or off, a sustaining period (C) in which discharges are generated in all of the selected display cells for displaying an image, and an eliminating period (D) in which discharges are stopped.

In the first embodiment, a reference voltage of the scanning electrodes 2 and the sustaining electrodes 3 is set equal to a sustaining voltage Vs which keeps discharges generated in the sustaining period (C), if applied to the scanning and sustaining electrodes 2 and 3. Hence, with respect to the scanning and sustaining electrodes 2 and 3, a voltage higher than the sustaining voltage Vs is expressed as a positive voltage, and a voltage lower than the sustaining voltage Vs is expressed as a negative voltage hereinafter. For instance, the sustaining voltage Vs is about +170 V. A reference voltage of the data electrodes 5 is set equal to zero (0) volt.

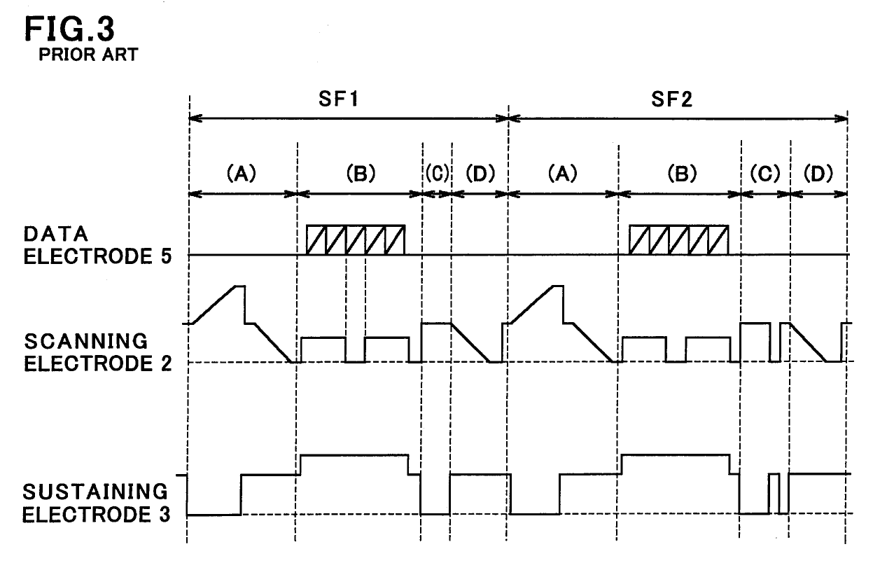

As is obvious in view of comparison of FIG. 4 with FIG. 3, pulses to be applied to electrodes in the second and third sub-fields (SF2 and SF3) have the same waveforms as those of the pulses in the first and second sub-fields in the conventional method illustrated in FIG. 3. Similarly, pulses to be applied to electrodes in fourth to eighth sub-fields (not illustrated) have the same waveforms as those of the pulses in third to seventh sub-fields (not illustrated) in the conventional method illustrated in FIG. 3.

The number of sustaining pulses to be applied to the electrodes in the sustaining period (C) in each of the fourth to eighth sub-fields is greater than the same in the third sub-field (SF3) by 2, 6, 14, 30 and 62, respectively. Hence, the method in accordance with the first embodiment is different from the conventional method only in the first sub-field (SF1). However, for better understanding of the first embodiment, an operation in the second and subsequent sub-fields is first explained.

In the preliminary discharge period (A), a positive and serrate preliminary discharge pulse Pps is applied to the scanning electrodes 2, and concurrently, a negative and rectangular preliminary discharge pulse Ppc is applied to the sustaining electrode 3. The preliminary discharge pulses Pps and Ppc are designed to have a wave-height or a maximum voltage higher than a threshold voltage at which discharge is generated between the scanning and sustaining electrodes 2 and 3. Accordingly, by applying the preliminary discharge pulses Pps and Ppc to the scanning and sustaining electrodes 2 and 3, respectively, weak discharge is generated between the scanning and sustaining electrodes 2 and 3 when the serrate preliminary discharge pulse Pps rises, and resultingly, a voltage between the scanning and sustaining electrodes 2 and 3 is over the above-mentioned threshold voltage. As a result, negative wall charges are accumulated on the scanning electrodes 2, and positive wall charges are accumulated on the sustaining electrodes 3.

Subsequently to the application of the preliminary discharge pulse Pps to the scanning electrodes 2, a negative and serrate preliminary discharge eliminating pulse Ppe is applied to the scanning electrodes 2, while the sustaining electrodes 3 are kept at the sustaining voltage Vs. By application of the preliminary discharge eliminating pulse Ppe, wall charges accumulated on the scanning and sustaining electrodes 2 and 3 are eliminated.

Elimination of the wall charges in the preliminary discharge period (A) causes the operation to be properly carried out in the subsequent periods.

In the selection period (B), all of the scanning electrodes 2 are once kept at a base voltage Vbw. Thereafter, a negative scanning pulse Pw is applied to each of the scanning electrodes 2 in turn, and a data pulse Pd is applied to the data electrodes 5 in accordance with display data. While application of the scanning pulse Pw and the data pulse Pd to the scanning electrodes 2 and the data electrodes 5, respectively, the sustaining electrodes 3 are kept at a positive voltage Vsw.

A voltage of the scanning pulse Pw and the data pulse Pd is determined such that if one of the scanning pulse Pw and the data pulse Pd is applied to the scanning electrodes 2 and the data electrodes 5, a voltage between the scanning electrodes 2 and the data electrodes 5 would not be over a threshold voltage at which discharge is generated between the scanning electrodes 2 and the data electrodes 5, but if both of the scanning pulse Pw and the data pulse Pd are applied to the scanning electrodes 2 and the data electrodes 5, a voltage between the scanning electrodes 2 and the data electrodes 5 would be over the threshold voltage.

In the selection period (B), the voltage Vsw of the sustaining electrodes 3 is designed to have such a magnitude that a voltage between the scanning and sustaining electrodes 2 and 3 is not over a threshold voltage at which discharge is generated between the scanning and sustaining electrodes 2 and 3, even if the voltage Vsw is added to the scanning pulse Pw.

Accordingly, discharge is generated between the scanning and data electrodes 2 and 5 only in display cells in which the scanning pulse Pw is applied to the scanning electrodes and the data pulse Pd is applied to the data electrodes 5. Since a voltage difference caused by the scanning pulses Pw and Vsw is applied across the scanning electrodes 2 and the sustaining electrodes 3, discharge is generated further between the scanning and sustaining electrodes 2 and 3 with the discharge generated between the scanning electrodes 2 and the data electrodes 5, acting as a trigger. The discharge between the scanning electrodes 2 and the sustaining electrodes 3 is so-called writing discharge.

As a result, positive wall charges are accumulated on the scanning electrodes 2, and negative wall charges are accumulated on the sustaining electrodes 3 in the selected display cells.

In the sustaining period (C), while all of the scanning electrodes 2 are kept at the sustaining voltage Vs, a first sustaining pulse Psf is applied to the sustaining electrodes 3. The sustaining voltage Vs is designed to have such a magnitude that discharge is generated between the scanning and sustaining electrodes 2 and 3, if a voltage caused by wall charges having been accumulated on the scanning and sustaining electrodes 2 and 3 by the writing discharge in the selection period (B) is added to the sustaining voltage Vs, but a voltage between the scanning and sustaining electrodes 2 and 3 would not be over a threshold voltage at which discharge is generated between the scanning and sustaining electrodes 2 and 3, and hence, discharge is not generated, if the voltage caused by the wall charges is not added to the sustaining voltages Vs.

Accordingly, a sustaining discharge is generated only in display cells in which wall charges are accumulated on the electrodes by the writing discharge having been generated in the selection period (B).

In the subsequent sub-fields, sustaining pulses Ps having a voltage equal to the sustaining voltage Vs and having phases opposite to each other are applied to the scanning and sustaining electrodes 2 and 3. As a result, a sustaining discharge is generated only in display cells in which a discharge has been generated by the first sustaining pulse Psf.

In the subsequent eliminating period (D), the sustaining electrodes 3 are kept at the sustaining voltage Vs, and a negative and serrate eliminating pulse Pe is applied to the scanning electrodes 2. Thus, wall charges accumulated on the scanning and sustaining electrodes 2 and 3 are eliminated. That is, the plasma display panel is returned back to its initial state, specifically, a state prior to the application of the preliminary discharge pulses Pps and Ppc into the scanning and sustaining electrodes 2 and 3 in the preliminary discharge period (A).

Elimination of the wall charges in the elimination period (D) causes the operation to be properly carried out in the subsequent periods.

Hereinbelow is explained an operation carried out in the first sub-field SF1 in comparison with the above-mentioned operation carried out in the second and third sub-fields (SF2 and SF3).

An operation to be carried out in the preliminary discharge period (A) and the selection period (B) is identical with the operation carried out in the second sub-field (SF2). However, the first sub-field (SF1) is designed not to include a sustaining period (C), and hence, the elimination period (D) is carried immediately after the selection period (B).

In the subsequent eliminating period (D) in the first sub-field, the scanning electrodes 2 are kept at the sustaining voltage Vs, and a negative and serrate eliminating pulse Per is applied to the sustaining electrodes 3. Then, the preliminary discharge period (A) in the second sub-field (SF2) starts.

In the selection period (B), discharge is generated between the scanning and sustaining electrodes 2 and 3 wherein discharge generated between the scanning and data electrodes 2 and 5 acts as a trigger and the scanning electrodes 2 act as a cathode. As a result of the discharge generated between the scanning and sustaining electrodes 2 and 3, positive wall charges are accumulated on the scanning electrodes 2, and negative wall charges are accumulated on the sustaining electrodes 3.

In the final sustaining discharge generated in the sustaining period (C) in the second and third sub-fields (SF2 and SF3), the sustaining electrodes 3 act as a cathode, and hence, negative wall charges are accumulated on the scanning electrodes 2, and positive wall charges are accumulated on the sustaining electrodes 3, oppositely to the wall charges accumulated in the selection period (B) in the first sub-field (SF1). Accordingly, elimination pulses to be applied to the electrodes in the elimination period (D) in the first sub-field (SF1) are designed to have opposite signs to signs of the elimination pulses applied in the second and third sub-fields (SF2 and SF3).

Since discharge generated in the selection period (B) has an intensity approximately equal to an intensity of sustaining discharge generated in the sustaining period (C) in the other sub-fields, a luminance accomplished in the first sub-field is equal to almost a half of a luminance in one sustaining cycle. The second sub-field (SF2) accomplishes a luminance corresponding to one sustaining cycle by virtue of discharge generated in the selection period (B) and one sustaining discharge generated in the sustaining period (C).

Summing up the explanation having been made above, Table 3 shows the number (X1) of cycles of sustaining pulses to be applied to the sustaining electrodes 3 in the sustaining period (C), the number (X2) of generation of sustaining discharges in the sustaining period (C), the number (X3) of generation of discharges in both of the sustaining period (C) and the selection period (B), and a proportion (X4) of a luminance in each of the sub-fields with a luminance in the first sub-field being as a reference luminance.

TABLE 3

| | SF1 | SF2 | SF3 | SF4 | SF5 | SF6 | SF7 | SF8 |
|---|---|---|---|---|---|---|---|---|
| X1 | 0 | 0.5 | 1.5 | 3.5 | 7.5 | 15.5 | 31.5 | 63.5 |
| X2 | 0 | 1 | 3 | 7 | 15 | 31 | 63 | 127 |
| X3 | 1 | 2 | 4 | 8 | 16 | 32 | 64 | 128 |
| X4 | 1 | 3 | 5 | 8 | 16 | 32 | 64 | 128 |

As shown in Table 3, a ratio in a luminance in the sub-fields constitutes 8-bit binary as originally designed, and it is possible to display an image at 256 gray scales by selection of the sub-fields. The number of sustaining cycles to be applied in a field is 123.5 cycles, and the number of sustaining cycles both in the sustaining and selection periods is 127.5 cycles, which is equal to a half of the same in the conventional method. Thus, the method in accordance with the first embodiment makes it possible to reduce power consumption with a gray scale being kept unchanged in displaying an image having a high average picture level (APL).

When an image is displayed at 9-bit and 512 gray scales, a ninth sub-field (SF9) having the number of sustaining cycles of 127.5 is added to the first to eighth sub-fields. As a result, the number of sustaining cycles per a field reaches 255.5 cycles including the discharges generated in the selection period (B), and hence, power consumption would be equal to the power consumption at 8-bit and 256 gray cycles in the conventional method.

As having been explained so far, the method of driving a plasma display panel in accordance with the first embodiment makes it possible to reduce power consumption without changing display performance at a certain gray scale, or enhance display performance at a certain gray scale without an increase in power consumption.

The method in accordance with the first embodiment may be accompanied with a problem in driving characteristics as follows.

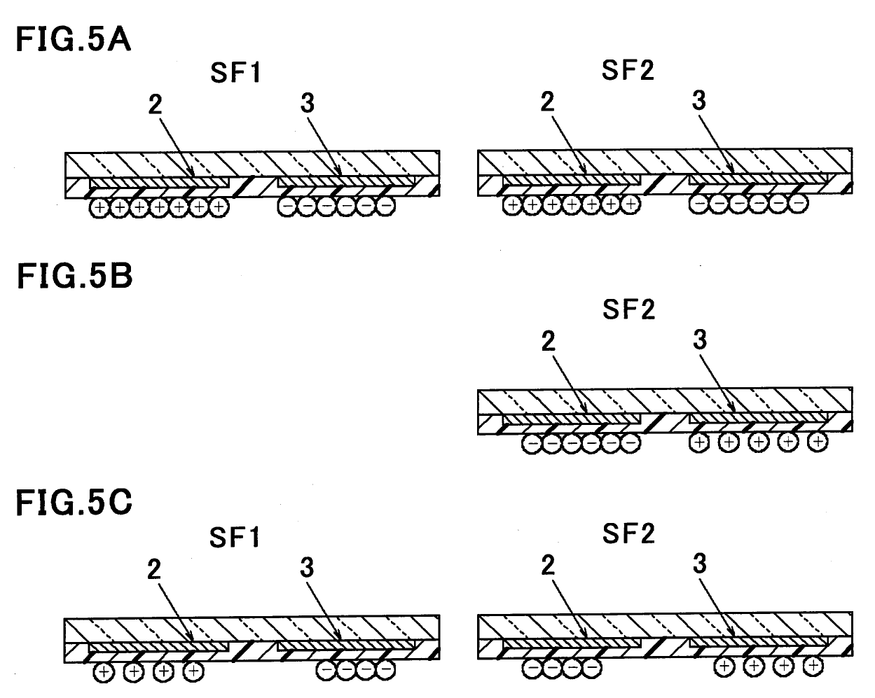

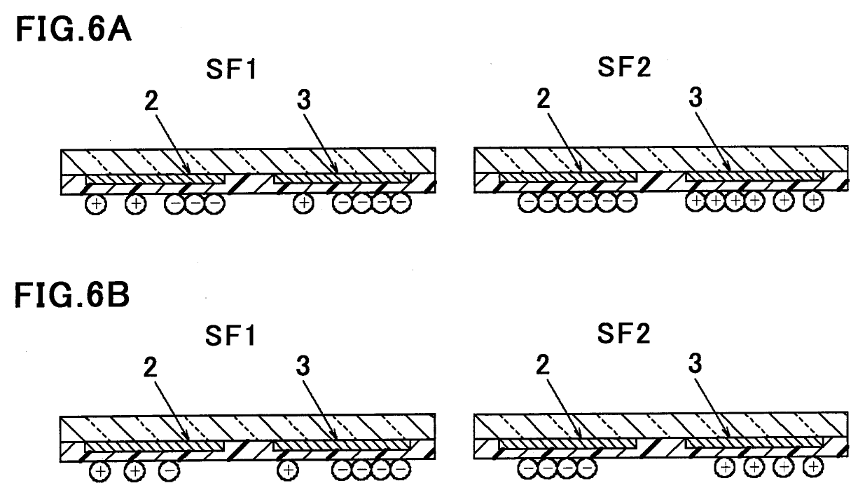

FIGS. 5A to 5C illustrate wall charges accumulated on the scanning and sustaining electrodes 2 and 3 in the selection period (B), the sustaining period (C) and the eliminating period (D), and FIGS. 6A and 6B illustrate wall charges accumulated on the scanning and sustaining electrodes 2 and 3 in preliminary discharge in the preliminary discharge period (A) and preliminary discharge elimination in the next sub-field.

Though the first and second sub-fields (SF1 and SF2) are shown in FIGS. 5A to 5C, 6A and 6B, the first sub-field does not include the sustaining period (C), as mentioned earlier.

As illustrated in FIG. 5A, at the termination of the selection period (B), positive wall charges are accumulated on the scanning electrodes 2 and negative wall charges are accumulated on the sustaining electrodes 3 in both of the first and second sub-fields (SF1 and SF2).

In the sustaining period (C), the final discharge is generated where the scanning electrodes 2 act as an anode and the sustaining electrodes 3 act as a cathode. Hence, as illustrated in FIG. 5B, negative wall charges are accumulated on the scanning electrodes 2 and positive wall charges are accumulated on the sustaining electrodes 3 in the second sub-field (SF2). As mentioned earlier, the first sub-field (SF1) does not include the sustaining period (C).

In the eliminating period (D), charge-eliminating pulses are applied to the sustaining electrodes 3 in the first sub-field (SF1), and to the scanning electrodes 2 in the second sub-field (SF2), resulting in that wall charges existing in the vicinity of a discharge gap are eliminated, as illustrated in FIG. 5C.

Since wall charges are eliminated by pulses having an inclined waveform in the first and second sub-fields (SF1 and SF2), discharge for eliminating wall charges is generated as a weak discharge even in the vicinity of a discharge gap, but wall charges existing remote from a discharge gap are not eliminated. Hence, wall charges are kept almost unchanged in an area remote from a discharge gap.

Then, in the preliminary discharge period (A) in the next sub-field, preliminary discharge is generated with the result that negative wall charges are accumulated on the scanning electrodes 2 in an area in the vicinity of a discharge gap and positive wall charges are accumulated on the sustaining electrodes 3 in an area in the vicinity of a discharge gap, as illustrated in FIG. 6A.

In the subsequent preliminary discharge elimination, wall charges accumulated on the scanning and sustaining electrodes 2 and 3 are eliminated in an area in the vicinity of a discharge gap, as illustrated in FIG. 6B. Since pulses having an inclined waveform is used in preliminary discharge and preliminary discharge elimination, discharge is generated only in the vicinity of a discharge gap, and wall charges existing in an area remote from a discharge gap are kept almost unchanged.

As a result, when an image is displayed in the second sub-field (SF2) in which the plasma display panel is driven in accordance with a method identical with the conventional method, and then, the next sub-field (SF3) starts, negative wall charges are accumulated on the scanning electrodes 2 and positive wall charges are accumulated on the sustaining electrodes 3.

In contrast, when an image is displayed in the first sub-field (SF1) in which the plasma display panel is driven in accordance with the first embodiment, and then, the next sub-field (SF2) starts, positive wall charges are accumulated on the scanning electrodes 2 and negative wall charges are accumulated on the sustaining electrodes 3 particularly in an area remote from a discharge area.

In the writing discharge generated in the selection period (B), the scanning electrodes 2 act as a cathode, and the data and sustaining electrodes 5 and 3 act as an anode. An electric field formed in a display cell by both positive wall charges accumulated on the scanning electrodes 2 and negative wall charges accumulated on the sustaining electrodes 3 is opposite in direction to an electric field externally applied for generating the writing discharge. Accordingly, the electric field formed in a display cell might be weakened, resulting in that the writing discharge might be difficult to be generated.

Hereinbelow is explained another method of driving a plasma display panel which method can solve the problem mentioned above.

[Second Embodiment]

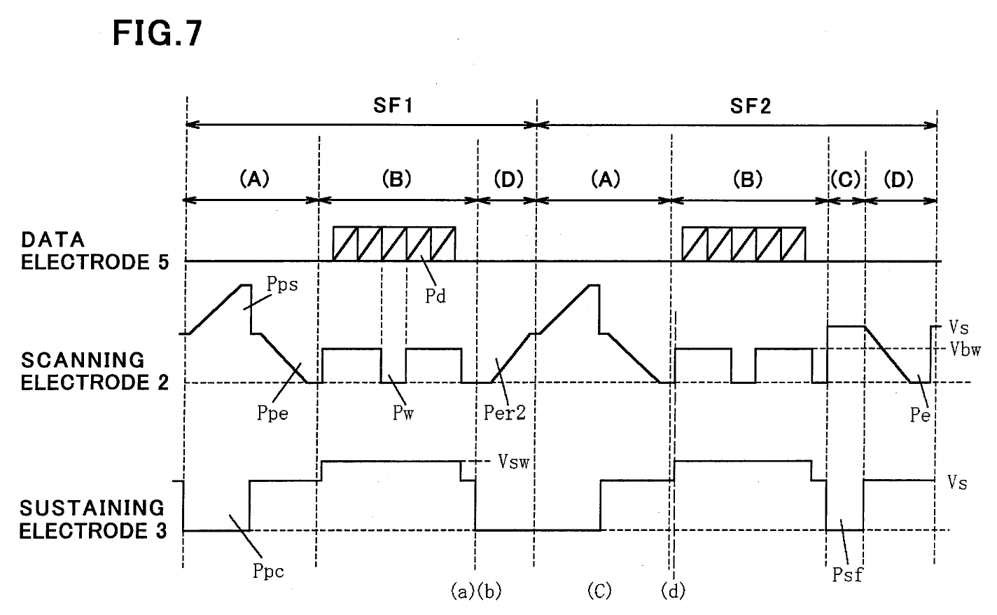

FIG. 7 is a timing chart showing waveforms of voltage pulses applied to scanning electrode, sustaining electrode and data electrode in a method of driving a plasma display panel, in accordance with the second embodiment of the present invention.

A first sub-field (SF1) is designed to have a weight of one (1), that is, the lowest weight. A second sub-field (SF2) is designed to have a weight of 2, and a third sub-field (SF3) is designed to have a weight of 4. FIG. 7 illustrates a case in which an average picture level (APL) of an image plane is relatively high, that is, the number of sustaining cycles per a field is reduced.

With reference to FIG. 7, the second sub-field (SF2) includes a preliminary discharge period (A) in which preliminary discharge pulses are applied to electrodes for causing discharges to be readily generated in the subsequent period (B), a selection period (B) in which it is selected which display cell or cells is(are) to be turned on or off, a sustaining period (C) in which discharges are generated in all of the selected display cells for displaying an image, and an eliminating period (D) in which discharges are stopped, whereas the first sub-field (SF1) does not include the sustaining period (C) similarly to the first embodiment.

In the second embodiment, a reference voltage of the scanning electrodes 2 and the sustaining electrodes 3 is set equal to a sustaining voltage Vs which keeps discharges generated in the sustaining period (C), when applied to the scanning and sustaining electrodes 2 and 3. Hence, with respect to the scanning and sustaining electrodes 2 and 3, a voltage higher than the sustaining voltage Vs is expressed as a positive voltage, and a voltage lower than the sustaining voltage Vs is expressed as a negative voltage hereinafter. For instance, the sustaining voltage Vs is about +170 V. A reference voltage of the data electrodes 5 is set equal to zero (0) volt.

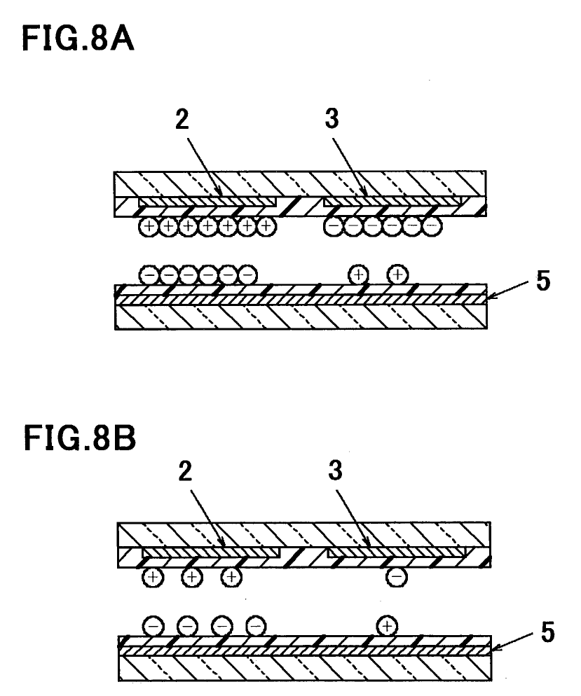

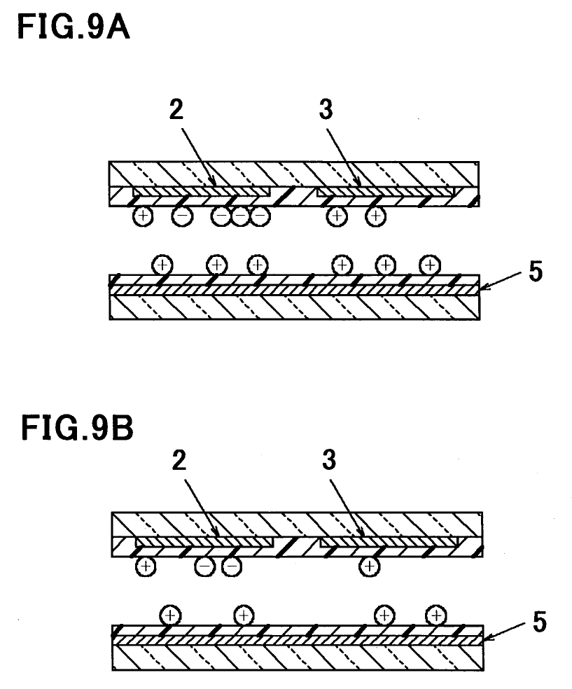

FIGS. 8A, 8B, 9A and 9B illustrate wall charges accumulated on the scanning and sustaining electrodes 2 and 3 in the preliminary discharge period (A), the selection period (B), the sustaining period (C) and the eliminating period (D).

Hereinbelow is explained the method in accordance with the second embodiment with reference to FIGS. 7, 8A, 8B, 9A and 9B.

In the preliminary discharge period (A), a positive and serrate preliminary discharge pulse Pps is applied to the scanning electrodes 2, and concurrently, a negative and rectangular preliminary discharge pulse Ppc is applied to the sustaining electrode 3. The preliminary discharge pulses Pps and Ppc are designed to have a wave-height or a maximum voltage higher than a threshold voltage at which discharge is generated between the scanning and sustaining electrodes 2 and 3. Accordingly, by applying the preliminary discharge pulses Pps and Ppc to the scanning and sustaining electrodes 2 and 3, respectively, weak discharge is generated between the scanning and sustaining electrodes 2 and 3 when the serrate preliminary discharge pulse Pps rises, and resultingly, a voltage between the scanning and sustaining electrodes 2 and 3 is over the above-mentioned threshold voltage. As a result, negative wall charges are accumulated on the scanning electrodes 2, and positive wall charges are accumulated on the sustaining electrodes 3.

Subsequently to the application of the preliminary discharge pulse Pps to the scanning electrodes 2, a negative and serrate preliminary discharge eliminating pulse Ppe is applied to the scanning electrodes 2, while the sustaining electrodes 3 are kept at the sustaining voltage Vs. By application of the preliminary discharge eliminating pulse Ppe, wall charges accumulated on the scanning and sustaining electrodes 2 and 3 are eliminated.

Elimination of the wall charges in the preliminary discharge period (A) causes the operation to be properly carried out in the subsequent periods.

In the selection period (B), all of the scanning electrodes 2 are once kept at a base voltage Vbw. Thereafter, a negative scanning pulse Pw is applied to each of the scanning electrodes 2 in turn, and a data pulse Pd is applied to the data electrodes 5 in accordance with display data. While application of the scanning pulse Pw and the data pulse Pd to the scanning electrodes 2 and the data electrodes 5, respectively, the sustaining electrodes 3 are kept at a positive voltage Vsw.

A voltage of the scanning pulse Pw and the data pulse Pd is determined such that if one of the scanning pulse Pw and the data pulse Pd is applied to the scanning electrodes 2 and the data electrodes 5, a voltage between the scanning electrodes 2 and the data electrodes 5 would not be over a threshold voltage at which discharge is generated between the scanning electrodes 2 and the data electrodes 5, but if both of the scanning pulse Pw and the data pulse Pd are applied to the scanning electrodes 2 and the data electrodes 5, a voltage between the scanning electrodes 2 and the data electrodes 5 would be over the threshold voltage.

In the selection period (B), the voltage Vsw of the sustaining electrodes 3 is designed to have such a magnitude that a voltage between the scanning and sustaining electrodes 2 and 3 is not over a threshold voltage at which discharge is generated between the scanning and sustaining electrodes 2 and 3, even if the voltage Vsw is added to the scanning pulse Pw.

Accordingly, discharge is generated between the scanning and data electrodes 2 and 5 only in display cells in which the scanning pulse Pw is applied to the scanning electrodes and the data pulse Pd is applied to the data electrodes 5. Since a voltage difference caused by the scanning pulses Pw and Vsw is applied across the scanning electrodes 2 and the sustaining electrodes 3, discharge is generated further between the scanning and sustaining electrodes 2 and 3 with the discharge generated between the scanning electrodes 2 and the data electrodes 5, acting as a trigger. The discharge between the scanning electrodes 2 and the sustaining electrodes 3 is so-called writing discharge.

As a result, positive wall charges are accumulated on the scanning electrodes 2, and negative wall charges are accumulated on the sustaining electrodes 3 in the selected display cells, as illustrated in FIG. 8A.

Then, in the elimination period (D), the scanning and sustaining electrodes 2 and 3 are kept at 0 V. Since negative wall charges are accumulated on the sustaining electrodes 3, an electric field is formed by the negative wall charges, and thus, discharge is generated between the sustaining electrodes 3 and the data electrodes 5 by virtue of the electric field in which the sustaining electrodes 3 act as a cathode and the data electrodes 5 act as an anode. Since the discharge generated between the sustaining electrodes 3 and the data electrodes 5 is caused only by the wall charges, the discharge has a small intensity.

However, at that time, wall charges remain much accumulated on the scanning electrodes 2, discharge is generated only by the wall charges between the scanning and sustaining electrodes 2 and 3 with the discharge generated between the sustaining electrodes 3 and the data electrodes 5, acting as a trigger. This discharge is called self-eliminating discharge. Self-eliminating discharge is generally quite intensive, because it is caused by much wall charges. The self-eliminating discharge in this case is not so intensive, because the wall charges are not intensive to generate self-eliminating discharge. However, the generation of the self-eliminating discharge reduces wall charges accumulated on the scanning and sustaining electrodes 2 and 3, as illustrated in FIG. 8B.

Then, while the sustaining electrodes 3 are kept at 0V, a serrate charge-eliminating pulse Per2 is applied to the scanning electrodes 2. By application of the charge-eliminating pulse Per2, wall charges existing in the vicinity of a discharge gap is completely eliminated.

In the subsequent preliminary discharge period (A) in the second sub-field (SF2), preliminary discharge (see FIG. 9A) and preliminary charge elimination (see FIG. 9B) are carried out, similarly to the first sub-field (SF1). As a result, positive wall charges are accumulated on the scanning electrodes 2 and negative wall charges are accumulated on the sustaining electrodes 3 both in smaller amount than the first embodiment prior to the selection period (B) in the second sub-field (SF2). Thus, writing discharge can be generated in the second sub-field (SF2) without any inhibition, ensuring desired driving characteristics.

As mentioned earlier, since the discharge generated between the sustaining electrodes 3 and the data electrodes 5 and the discharge generated between the scanning electrodes 2 and the sustaining electrodes 3 both in the elimination period (D) are caused by not so much wall charges, and hence, have a small intensity, the discharges do not exert much influence on a luminance in the first sub-field (SF1) which luminance is set equal to a half of a luminance of one sustaining cycle, ensuring no deterioration in gray scale controllability.

The second embodiment is different from the first embodiment as follows.

After the selection period (B), the scanning and sustaining electrodes 2 and 3 are kept at a common voltage, that is, the sustaining voltage Vs in the second embodiment, similarly to the first embodiment. Positive wall charges are accumulated on the scanning electrodes 2, and negative wall charges are accumulated on the data electrodes 5. However, since the phosphor layer 8 formed on the data electrodes 5 has a low electron-emission coefficient, discharge in which the data electrodes 5 act as a cathode starts at a voltage higher than a voltage at which discharge in which the scanning or sustaining electrodes 2 or 3 act as a cathode starts. Hence, in the method in accordance with the second embodiment, discharge is not generated between the scanning and data electrodes 2 and 5, and resultingly, self-eliminating discharge is not generated between the scanning and sustaining electrodes 2 and 3.

The voltage Vsw has to be determined in accordance with characteristics of a display cell in order to generate discharge between the sustaining and data electrodes 3 and 5 in the elimination period (D). The scanning and sustaining electrodes 2 and 3 are kept at 0V at the start of the elimination period (D) in the second embodiment, however, it should be noted that it is not always necessary to keep the electrodes 2 and 3 at 0V. In addition, it is not always necessary to keep the scanning and sustaining electrodes 2 and 3 at a common voltage. The scanning and sustaining electrodes 2 and 3 may be kept at different voltages from each other, if the voltages are determined such that wall charged are reduced with discharge generated between the sustaining and data electrodes 3 and 5, acting as a trigger.

In the second embodiment, the charge-eliminating pulse Per2 are applied to the scanning electrodes 2 independently from the preliminary discharge pulse Pps in the next sub-field. However, it is not always necessary to apply them to the scanning electrodes 2 separately from each other, but they may be applied to the scanning electrodes 2 together as a sequential pulse.

As mentioned above, there is some designability in determining the voltages, but it is sometimes difficult to generate discharge between the sustaining electrodes 3 and the data electrodes 5 in accordance with characteristics of a display cell. In the next embodiment, there is explained a method of driving a plasma display panel which method is capable of surely generating discharge between the sustaining and data electrodes 3 and 5.

[Third Embodiment]

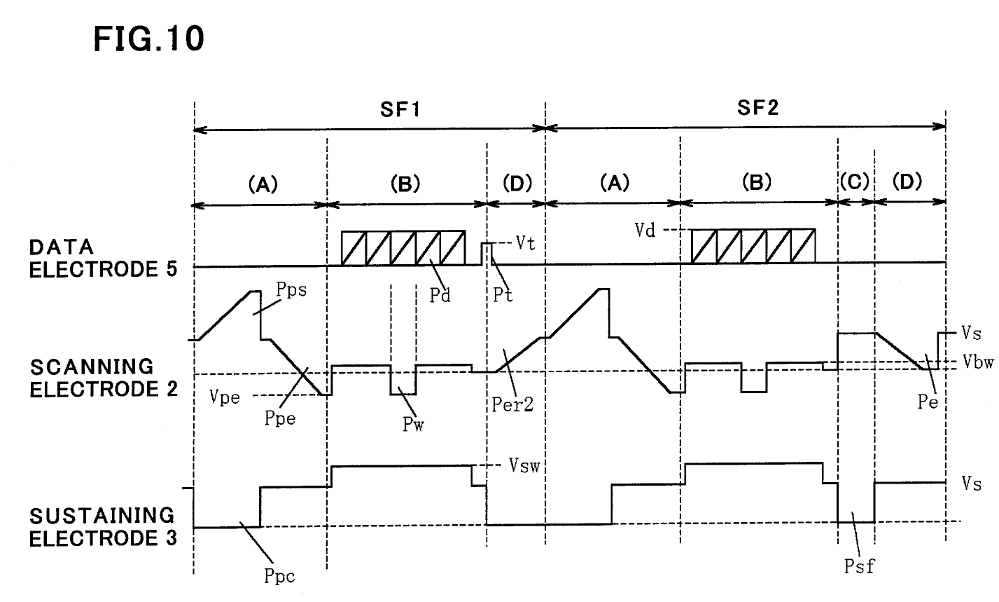

FIG. 10 is a timing chart showing waveforms of voltage pulses applied to scanning electrode, sustaining electrode and data electrode in a method of driving a plasma display panel, in accordance with the third embodiment of the present invention.

A first sub-field (SF1) is designed to have a weight of one (1), that is, the lowest weight. A second sub-field (SF2) is designed to have a weight of 2. FIG. 10 illustrates a case in which an average picture level (APL) of an image plane is relatively high, that is, the number of sustaining cycles per a field is reduced.

With reference to FIG. 10, the second sub-field (SF2) includes a preliminary discharge period (A) in which preliminary discharge pulses are applied to electrodes for causing discharges to be readily generated in the subsequent period (B), a selection period (B) in which it is selected which display cell or cells is(are) to be turned on or off, a sustaining period (C) in which discharges are generated in all of the selected display cells for displaying an image, and an eliminating period (D) in which discharges are stopped, whereas the first sub-field (SF1) does not include the sustaining period (C), similarly to the first and embodiments.

In the third embodiment, a reference voltage of the scanning electrodes 2 and the sustaining electrodes 3 is set equal to a sustaining voltage Vs which keeps discharges generated in the sustaining period (C), when applied to the scanning and sustaining electrodes 2 and 3. Hence, with respect to the scanning and sustaining electrodes 2 and 3, a voltage higher than the sustaining voltage Vs is expressed as a positive voltage, and a voltage lower than the sustaining voltage Vs is expressed as a negative voltage hereinafter. For instance, the sustaining voltage Vs is about +170 V. A reference voltage of the data electrodes 5 is set equal to zero (0) volt.

Hereinbelow is explained the method in accordance with the third embodiment with reference to FIG. 10.

In the preliminary discharge period (A), a positive and serrate preliminary discharge pulse Pps is applied to the scanning electrodes 2, and concurrently, a negative and rectangular preliminary discharge pulse Ppc is applied to the sustaining electrode 3. The preliminary discharge pulses Pps and Ppc are designed to have a wave-height or a maximum voltage higher than a threshold voltage at which discharge is generated between the scanning and sustaining electrodes 2 and 3. Accordingly, by applying the preliminary discharge pulses Pps and Ppc to the scanning and sustaining electrodes 2 and 3, respectively, weak discharge is generated between the scanning and sustaining electrodes 2 and 3 when the serrate preliminary discharge pulse Pps rises, and resultingly, a voltage between the scanning and sustaining electrodes 2 and 3 is over the above-mentioned threshold voltage. As a result, negative wall charges are accumulated on the scanning electrodes 2, and positive wall charges are accumulated on the sustaining electrodes 3.

Subsequently to the application of the preliminary discharge pulse Pps to the scanning electrodes 2, a negative and serrate preliminary discharge eliminating pulse Ppe is applied to the scanning electrodes 2, while the sustaining electrodes 3 are kept at the sustaining voltage Vs. By application of the preliminary discharge eliminating pulse Ppe, wall charges accumulated on the scanning and sustaining electrodes 2 and 3 are eliminated.

Elimination of the wall charges in the preliminary discharge period (A) causes the operation to be properly carried out in the subsequent periods.

In the selection period (B), all of the scanning electrodes 2 are once kept at a base voltage Vbw. Thereafter, a negative scanning pulse Pw is applied to each of the scanning electrodes 2 in turn, and a data pulse Pd is applied to the data electrodes 5 in accordance with display data. While application of the scanning pulse Pw and the data pulse Pd to the scanning electrodes 2 and the data electrodes 5, respectively, the sustaining electrodes 3 are kept at a positive voltage Vsw.

A voltage Vd of the scanning pulse Pw and the data pulse Pd is determined such that if one of the scanning pulse Pw and the data pulse Pd is applied to the scanning electrodes 2 and the data electrodes 5, a voltage between the scanning electrodes 2 and the data electrodes 5 would not be over a threshold voltage at which discharge is generated between the scanning electrodes 2 and the data electrodes 5, but if both of the scanning pulse Pw and the data pulse Pd are applied to the scanning electrodes 2 and the data electrodes 5, a voltage between the scanning electrodes 2 and the data electrodes 5 would be over the threshold voltage.

The voltage Vsw of the sustaining electrodes 3 in the selection period (B) is designed to have such a magnitude that a voltage between the scanning and sustaining electrodes 2 and 3 is not over a threshold voltage at which discharge is generated between the scanning and sustaining electrodes 2 and 3, even if the voltage Vsw is added to the scanning pulse Pw.

Accordingly, discharge is generated between the scanning and data electrodes 2 and 5 only in display cells in which the scanning pulse Pw is applied to the scanning electrodes 2 and the data pulse Pd is applied to the data electrodes 5. Since a voltage difference caused by the scanning pulses Pw and Vsw is applied across the scanning electrodes 2 and the sustaining electrodes 3, discharge is generated further between the scanning and sustaining electrodes 2 and 3 with the discharge generated between the scanning electrodes 2 and the data electrodes 5, acting as a trigger. The discharge between the scanning electrodes 2 and the sustaining electrodes 3 is so-called writing discharge.

As a result, positive wall charges are accumulated on the scanning electrodes 2, and negative wall charges are accumulated on the sustaining electrodes 3 in the selected display cells.

Then, in the elimination period (D), the scanning and sustaining electrodes 2 and 3 are kept at 0 V, while a trigger pulse Pt having a voltage of Vt is applied to all of the data electrodes 5. Since negative wall charges are much accumulated on the sustaining electrodes 3 in a display cell in which the writing discharge was generated, discharge is generated between the sustaining electrodes 3 and the data electrodes 5 in which the sustaining electrodes 3 act as a cathode and the data electrodes 5 act as an anode, by virtue of the trigger pulse Pt and the accumulated wall charges. As a result, similarly to the second embodiment, discharge is generated only by virtue of wall charges between the scanning and sustaining electrodes 2 and 3, in which the discharge having been generated between the sustaining electrodes 3 and the data electrodes 5 acts as a trigger, and hence, wall charges accumulated on the scanning and sustaining electrodes 2 and 3 are reduced.

Thus, similarly to the second embodiment, writing discharge is generated in the subsequent sub-field without any inhibition, and desired driving characteristics can be obtained. Since the discharge generated between the sustaining and data electrodes 3 and 5 merely acts as a trigger for generating self-eliminating discharge between the scanning and sustaining electrodes 2 and 3, the discharge generated between the sustaining and data electrodes 3 and 5 is designed to have such an intensity as deteriorating gray scale controllability, by controlling the voltage Vt of the trigger pulse Pt.

In the method in accordance with the third embodiment, the trigger pulse Pt is applied to the data electrodes 5 in non-selected display cells. However, during application of the trigger pulse Pt to the data electrodes 5, the scanning electrodes 2 are kept at 0V, and hence, is higher in voltage than the scanning pulse Pw by the voltage Vpe. Accordingly, if the voltage Vt of the trigger pulse Pt is designed lower than an absolute value of the voltage Vpe, discharge is not generated between the scanning and data electrodes 2 and 5. Thus, the voltage Vt of the trigger pulse Pt can be designed with high designability to make it possible to generate discharge between the sustaining and data electrodes 3 and 5.

In addition, if an absolute value of the voltage Vpe is designed higher than the voltage Vd of the data pulse Pd in the selection period (B), it would be possible to equalize the voltages Vt and Vd to each other, in which case, it is not necessary to provide additional functions to a circuit which drives the data electrodes 5, ensuring no increase in fabrication cost.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2002-179734 filed on Jun. 20, 2002 including specification, claims, drawings and summary is incorporated herein by reference in its entirety.

What is claimed is:

1. A method of driving a plasma display panel including:
(a) a first substrate;
(b) a second substrate located facing said first substrate;
(c) a plurality of first electrodes arranged on a surface of said first substrate which surface faces said second substrate, and extending in a first direction;
(d) a plurality of second electrodes arranged on said surface of said first substrate and extending in said first direction such that each of said second electrodes makes a pair with each of said first electrodes located adjacent thereto; and
(e) a plurality of third electrodes arranged on a surface of said second substrate which surface faces said first substrate, and extending in a second direction perpendicular to said first direction,
wherein a display cell is arranged at each of intersections of said first/second electrodes and said third electrodes,
said method includes the steps of:
(a) dividing a field into a plurality of sub-fields having at least two weighted luminance;
(b) selecting whether discharge is to be generated between said first or second and third electrodes for controlling a gray scale;
(c) weighting said luminance by varying the number of application of sustaining pulses to said first or second electrode; and
(d) stopping application of said sustaining pulses to said first or second electrode in at least one sub-field among said plurality of sub-fields.

2. The method as set forth in claim 1, wherein said sub-field in which application of said sustaining pulses to said first or second electrode is stopped includes a step (e) of generating discharge between said first and second electrodes in said step (b).

3. The method as set forth in claim 1, wherein said sub-field in which application of said sustaining pulses to said first or second electrode is stopped includes a step (f) of reducing at least one of wall charges accumulated on a surface of said first electrode and wall charges accumulated on a surface of said second electrode after said step (b).

4. The method as set forth in claim 3, wherein said step (f) includes a step (g) of generating self-eliminating discharge by virtue of said wall charges accumulated on surfaces of said first and second electrodes.

5. The method as set forth in claim 3, wherein said step (f) includes a step (h) of generating discharge between said second and third electrodes.

6. The method as set forth in claim 4, wherein said step (g) is caused by a step (i) of generating discharge between said second and third electrodes.

7. The method as set forth in claim 6, wherein said discharge in said step (i) is self-eliminating discharge generated by virtue of wall charges accumulated on surfaces of said second and third electrodes.

8. The method as set forth in claim 1, wherein said sub-field in which application of said sustaining pulses to said first or second electrode is stopped provides the lowest luminance in said field.

9. A method of driving a plasma display panel including:
(a) a first substrate;
(b) a second substrate located facing said first substrate;
(c) a plurality of first electrodes arranged on a surface of said first substrate which surface faces said second substrate, and extending in a first direction;
(d) a plurality of second electrodes arranged on said surface of said first substrate and extending in said first direction such that each of said second electrodes makes a pair with each of said first electrodes located adjacent thereto; and
(e) a plurality of third electrodes arranged on a surface of said second substrate which surface faces said first substrate, and extending in a second direction perpendicular to said first direction,
wherein a display cell is arranged at each of intersections of said first/second electrodes and said third electrodes,
said method includes the steps of:
(a) dividing a field into a plurality of sub-fields having at least two weighted luminance;
(b) selecting whether discharge is to be generated between said first or second and third electrodes for controlling a gray scale;
(c) weighting said luminance by varying the number of application of sustaining pulses to said first or second electrode;
(d) varying the total number of said sustaining pulses to be applied to said first or second electrode during a field, in accordance with brightness of images; and
(e) stopping application of said sustaining pulses to said first or second electrode in at least one sub-field among said plurality of sub-fields, when said total number of said sustaining pulses is equal to or smaller than a threshold.

10. The method as set forth in claim 9, wherein said sub-field in which application of said sustaining pulses to said first or second electrode is stopped includes a step (e) of generating discharge between said first and second electrodes in said step (b).

11. The method as set forth in claim 9, wherein said sub-field in which application of said sustaining pulses to said first or second electrode is stopped includes a step (f) of reducing at least one of wall charges accumulated on a surface of said first electrode and wall charges accumulated on a surface of said second electrode after said step (b).

12. The method as set forth in claim 11, wherein said step (f) includes a step (g) of generating self-eliminating discharge by virtue of said wall charges accumulated on surfaces of said first and second electrodes.

13. The method as set forth in claim 11, wherein said step (f) includes a step (h) of generating discharge between said second and third electrodes.

14. The method as set forth in claim 12, wherein said step (g) is caused by a step (i) of generating discharge between said second and third electrodes.

15. The method as set forth in claim 14, wherein said discharge in said step (i) is self-eliminating discharge generated by virtue of wall charges accumulated on surfaces of said second and third electrodes.

16. The method as set forth in claim 9, wherein said sub-field in which application of said sustaining pulses to said first or second electrode is stopped provides the lowest luminance in said field.

17. A plasma display panel including:
(a) a first substrate;
(b) a second substrate located facing said first substrate;
(c) a plurality of first electrodes arranged on a surface of said first substrate which surface faces said second substrate, and extending in a first direction;
(d) a plurality of second electrodes arranged on said surface and extending in said first direction such that each of said second electrodes makes a pair with each of said first electrodes located adjacent thereto; and
(e) a plurality of third electrodes arranged on a surface of said second substrate which surface faces said first substrate, and extending in a second direction perpendicular to said first direction,
wherein a display cell is arranged at each of intersections of said first/second electrodes and said third electrodes,
a field is divided into a plurality of sub-fields having at least two weighted luminance,
a gray scale is controlled by selecting whether discharge is to be generated between said first or second and third electrodes,
the number of application of sustaining pulses to said first or second electrode is varied for weighting said luminance, and
application of said sustaining pulses to said first or second electrode is stopped in at least one sub-field among said plurality of sub-fields.

18. The plasma display panel as set forth in claim 17, wherein said sub-field in which application of said sustaining pulses to said first or second electrode is stopped provides the lowest luminance in said field.

19. A plasma display panel including:
(a) a first substrate;
(b) a second substrate located facing said first substrate;
(c) a plurality of first electrodes arranged on a surface of said first substrate which surface faces said second substrate, and extending in a first direction;
(d) a plurality of second electrodes arranged on said surface and extending in said first direction such that each of said second electrodes makes a pair with each of said first electrodes located adjacent thereto; and
(e) a plurality of third electrodes arranged on a surface of said second substrate which surface faces said first substrate, and extending in a second direction perpendicular to said first direction,
wherein a display cell is arranged at each of intersections of said first/second electrodes and said third electrodes,
a field is divided into a plurality of sub-fields having at least two weighted luminance,
a gray scale is controlled by selecting whether discharge is to be generated between said first or second and third electrodes,
the number of application of sustaining pulses to said first or second electrode is varied for weighting said luminance,
the total number of said sustaining pulses to be applied to said first or second electrode during a field is varied in accordance with brightness of images, and
application of said sustaining pulses to said first or second electrode is stopped in at least one sub-field among said plurality of sub-fields, when said total number of said sustaining pulses is equal to or smaller than a threshold.

20. The plasma display panel as set forth in claim 19, wherein said sub-field in which application of said sustaining pulses to said first or second electrode is stopped provides the lowest luminance in said field.
